(19) United States
(12) Patent Application Publication
(10) Pub. No.: US 2020/0280115 A1
(43) Pub. Date: Sep. 3, 2020

(54) INTEGRATED FILTER SYSTEM AND ANTENNA SYSTEM

(71) Applicant: TONGYU COMMUNICATION INC., Zhongshan City, Guandong (CN)

(72) Inventors: Hui CAI, Zhongshan City (CN); Pengbo WANG, Zhongshan City (CN); Qi ZHOU, Zhongshan City (CN); Jianzhao YU, Zhongshan City (CN); Yudong LIANG, Zhongshan City (CN); Qilue FU, Zhongshan City (CN); Gang JU, Zhongshan City (CN)

(73) Assignees: TONGYU COMMUNICATION INC., Zhongshan City, Guandong (CN); TONGYU COMMUNICATION INC., Zhongshan City, Guandong (CN)

(21) Appl. No.: 16/479,851

(22) PCT Filed: Jan. 20, 2017
(86) PCT No.: PCT/CN2017/071862

§ 371 Date: Jul. 22, 2019

(51) Int. Cl. H01P 1/203; H01P 1/20; H01Q 13/20

(52) U.S. Cl. CPC H01P 1/20309; H01Q 13/206; H01P 1/2002

(57) ABSTRACT

An integrated filter system, including: a dielectric slab assembly; and a filter circuit arranged on the dielectric slab assembly, where the filter circuit includes a low-pass filter and a band-pass filter connected to one another in series. The present invention further discloses an antenna system. By means of the foregoing implementations, the filter system and the antenna system are integrated and miniaturized and have smaller weights, and the filter system and the antenna system have a simple structure and lower costs, and stable and reliable whole performance.

### BACKGROUND

### Technical Field

The present invention relates to the technical field of mobile communications, and in particular, to an integrated filter system and an antenna system.

### Related Art

An antenna and a filter are most important two key components among passive components, and play important roles in a wireless communications system.

An antenna achieves an effect of transmitting and receiving a wireless electromagnetic signal, a microwave filter achieves effects of selecting a signal, attenuating noise, filtering out image interference and the like, and a commonly used filter is a cavity filter. With the development of wireless communications, high-performance portable terminal devices are increasingly needed, which requires miniaturization and integration of the antenna and the filter.

At present, the antenna and the filter are independent modules, the conventional filter-antenna system design method focuses on antenna and filter components themselves, and independent design and optimization are carried out according to standard impedance units.

As shown in FIG. 1, due to differences in specifications of an antenna, a connector and the like, a connector (not shown in the figure) needs to be added between the antenna and the filter, which increases a volume and costs. In addition, for a cavity band-pass filter 1′, a metal connecting rod low-pass filter 2′ further needs to be added usually to suppress a high-frequency harmonic, which further increases the volume and costs of the filter. Finally, for some situations requiring strict suppression indicators, the cavity band-pass filter 1′ usually has a greater quantity of cavities and a greater volume. Therefore, the integration and miniaturization of a filter antenna system is greatly limited due to limitations in structures of the connector and the metal connecting rod low-pass filter 2′, a great quantity of cavities of the cavity band-pass filter 1′ and other causes.

To resolve the foregoing technical problems, the present invention provides an integrated filter system and an antenna system, so that the filter system and the antenna system are integrated and miniaturized and have smaller weights, and the filter system and the antenna system have a simple structure and lower costs, and have stable and reliable whole performance.

### SUMMARY

### Technical Problems

To solve the foregoing technical problems, the present invention provides an integrated filter system, including: a dielectric slab assembly; and a filter circuit arranged on the dielectric slab assembly, where the filter circuit includes a low-pass filter and a band-pass filter connected to one another in series.

### Technical Solutions

Further, the dielectric slab assembly includes a dielectric slab, and the low-pass filter and the band-pass filter are both arranged on the dielectric slab.

Further, the dielectric slab assembly includes two dielectric slabs, the low-pass filter is arranged on one dielectric slab, and the band-pass filter is arranged on the other dielectric slab.

Further, the low-pass filter is a microstrip low-pass filter.

Further, the low-pass filter is a high-low-impedance microstrip low-pass filter.

Further, the band-pass filter is a microstrip band-pass filter.

Further, the microstrip band-pass filter implements a part of band-pass functions, and the microstrip band-pass filter and an externally-connected cavity band-pass filter jointly achieve a band-pass filtering effect.

Further, the dielectric slab is a PCB.

Further, the integrated filter system includes a coaxial cavity filter electrically connected to the band-pass filter.

Further, the coaxial cavity filter is a band-pass filter.

Further, the coaxial cavity filter is configured to achieve a part of band-pass filtering effects.

Further, the band-pass filter and the coaxial cavity filter are connected to one another by means of a cable.

Further, the cable is connected to the band-pass filter and the coaxial cavity filter in a welding or screw fastening manner.

To solve the foregoing technical problems, the present invention further provides an antenna system, including the integrated filter system according to any one of the foregoing embodiments; an antenna feeding network in the antenna system and the integrated filter system are integrated to a same dielectric slab assembly.

Further, the antenna feeding network is a microstrip antenna feeding network.

Beneficial Effects of the Present Invention

Beneficial Effects

The integrated filter system and the antenna system in the present invention have the following beneficial effects:

(1) By integrating the filter circuit, that is, the low-pass filter and the band-pass filter, to the dielectric slab assembly, the metal connecting rod low-pass filter in the conventional technology may be omitted, so that integration, miniaturization and lightweight are achieved, and costs are reduced.

(2) By respectively arranging the low-pass filter and the band-pass filter in the filter circuit as a microstrip form, integration, miniaturization and lightweight are further achieved, and the stability of the whole performance is improved.

(3) A coaxial cavity filter is added in the integrated filter system, and by means of the advantages of a great Q value and a good rectangle coefficient and the like of the coaxial cavity filter, disadvantages of a great Q value and a great insertion loss value of the microstrip-type filter may be remedied, thereby further satisfying the whole performance requirement. In addition, because the integrated filter system itself has good filtering performance, requirements on the quantity of cavities of the cavity filter may be reduced.

(4) By wholly integrating the antenna feeding network into the integrated filter system, the antenna feeding network itself has a certain filtering feature, so that the antenna feeding network may be conveniently applied to the antenna and the antenna system, which helps to achieve the integration and miniaturization. In addition, the antenna feeding network may be directly connected to the filter circuit 2 in the integrated filter system, so that a connector required in the conventional technology may be omitted.

### BRIEF DESCRIPTION OF THE DRAWINGS

FIG. 1 is a perspective view of a filter module in a conventional technology;

FIG. 2 is a perspective view of an antenna according to an embodiment of the present invention; and

FIG. 3 is a perspective view of an antenna system according to an embodiment of the present invention.

### DETAILED DESCRIPTION

### Preferred Embodiments for Executing the Present Invention

### Preferred Implementations of the Present Invention

The present invention will be described below in detail with reference to the accompanying drawings and implementations.

Refer to FIG. 2. The present invention provides an integrated filter system. The integrated filter system includes a dielectric slab assembly 1 and a filter circuit 2 arranged on the dielectric slab assembly 1. The filter circuit 2 includes a low-pass filter 21 and a band-pass filter 22 connected to one another in series.

The low-pass filter 21 may suppress a high-order harmonic wave, and the band-pass filter 22 implements a part of outband suppression functions. By arranging the low-pass filter 21 and the band-pass filter 22 on the same dielectric slab assembly 1, integration and miniaturization may be achieved.

Further, in an embodiment, the dielectric slab assembly 1 merely includes a dielectric slab, and the low-pass filter 21 and the band-pass filter 22 are both disposed on the dielectric slab.

Further, in another embodiment, the dielectric slab assembly 1 may also comprise two dielectric slabs, the low-pass filter 21 is arranged on one dielectric slab, and the band-pass filter 22 is arranged on the other dielectric slab.

In the foregoing two embodiments, the low-pass filter 21 is a microstrip low-pass filter, which is arranged on a corresponding dielectric slab. By configuring the low-pass filter 21 as a microstrip low-pass filter, a metal connecting rod low-pass filter 2′ in the conventional technology may be completely replaced, which may greatly decrease a volume of the integrated filter system and reduces costs.

Preferably, the low-pass filter 21 may be a high-low impedance microstrip low-pass filter. As shown in FIG. 2, the low-pass filter 21 may be an order high-low impedance microstrip low-pass filter.

In the foregoing embodiments, the band-pass filter 22 is a microstrip band-pass filter, which is arranged on a corresponding dielectric slab. By configuring the band-pass filter 22 as a microstrip band-pass filter, the volume of the integrated filter system may be greatly decreased and costs are reduced.

In an embodiment, the band-pass filter 22 includes two open quadrilateral microstrips, and the two open quadrilateral microstrips are symmetrically arranged and are close adjacent at the openings and transmit signals in a coupling manner. Preferably, each open quadrilateral is roughly a notched quadrilateral, where a short line in the middle of the notched quadrilateral is not closed. One open quadrilateral is electrically connected to the low-pass filter 21, and the other open quadrilateral is configured to electrically connect to an externally independently disposed cavity band-pass filter.

The microstrip band-pass filter may implement a part of band-pass functions, and the microstrip band-pass filter and an externally-connected cavity band-pass filter jointly achieve a band-pass filtering effect.

In another embodiment, the band-pass filter in the filter circuit 2 may also be implemented by serially connecting a low-pass filter and a high-pass filter. Likewise, the low-pass filter and the high-pass filter used for implementing the band-pass filter in the filter circuit 2 may also be configured as a microstrip form.

In the foregoing embodiments, each dielectric slab may be a PCB having a great dielectric constant and good insulation performance. Certainly, each dielectric slab may also be, for example, a Rogers board, and the like.

In an application embodiment, the integrated filter system may further include a coaxial cavity filter 3 electrically connected to the band-pass filter 22.

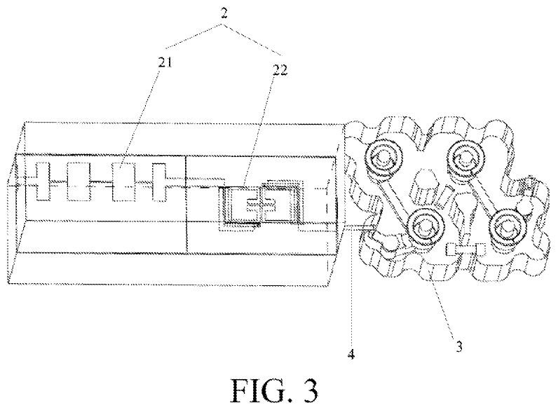

Usually, the coaxial cavity filter 3 is configured to achieve a part of band-pass filtering effects, and may be a band-pass filter. As shown in FIG. 3, the coaxial cavity filter 3 may be a cavity band-pass filter having four cavities.

Usually, the band-pass filter 22 in the filter circuit 2 and the coaxial cavity filter 3 may be connected by means of a cable 4. The cable 4 is usually a standard cable, the standard cable is usually a 50Ω standard cable, and certainly, the standard cable may also be a non-50Ω standard cable, which is not excessively limited herein. Certainly, the band-pass filter 22 in the filter circuit 2 and the coaxial cavity filter 3 may also be connected in another way except a cable.

Preferably, the cable 4 may be connected to the band-pass filter 22 and the coaxial cavity filter 3 in a welding or screw fastening manner or other manners, to improve the reliability of the connection.

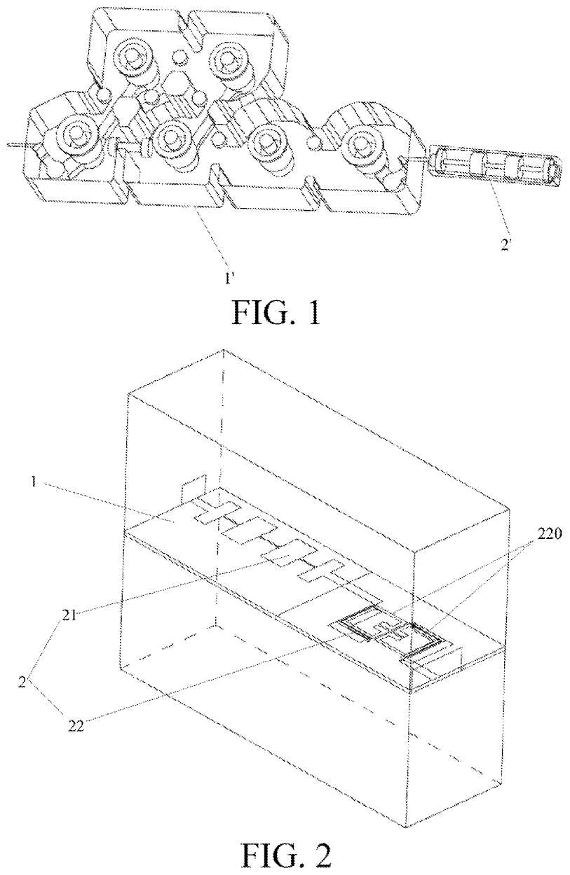

The microstrip-type filters in the present invention, which are the microstrip low-pass filter and the microstrip band-pass filter, have a Q value less than that of the coaxial cavity filter 3 and possibly have greater insertion loss and a poor rectangle coefficient; however, the coaxial cavity filter 3 has a greater Q value and a good rectangle coefficient and may remedy the disadvantage. Therefore, such a coaxial cavity filter 3 is added in the present invention. The filtering functions of the microstrip-type filter reduce the pressure of the coaxial cavity filter 3 and lower performance requirements on the coaxial cavity filter 3, and therefore, the quantity of cavities (an order) of the coaxial cavity filter 3 may be reduced, the coaxial cavity filter 3 merely needs to be configured as a cavity band-pass filter provided with four cavities (as shown in FIG. 3), and functions of the cavity band-pass filter 1′ provided with six cavities as shown in FIG. 1 in the conventional technology are implemented; the volume and the weight of the coaxial cavity filter 3 are reduced by more than one third and costs are greatly reduced compared with the metal connecting rod low-pass filter 2′ and the cavity band-pass filter 1′ provided with six cavities in the conventional technology.

The integrated filter system in the present invention is applicable to antennas and antenna systems in the field of mobile communications, and is particularly applicable to be used in 5G mobile communications, and particularly, may well suppress high-order harmonic waves that possibly occur outside a required frequency band in 5G mobile communications.

In addition, the present invention further provides an antenna system, and the antenna system includes the integrated filter system according to any one of the foregoing embodiments.

Preferably, the antenna feeding network (not shown in the figure) in the antenna system and the integrated filter system are integrated to a same dielectric slab assembly.

Specifically, the antenna feeding network may be arranged on a dielectric slab where the low-pass filter 21 and/or the band-pass filter 22 are arranged, for example, the dielectric slab 1. A free space of the dielectric slab on which the low-pass filter 21 and/or the band-pass filter 22 are arranged is used to arrange the antenna feeding network, to improve the utilization rate of an effective space on the dielectric slab, which helps to decrease the volume of the whole integrated filter system and achieve integration and miniaturization.

Certainly, the antenna feeding network may also be arranged on the other dielectric slab on which the low-pass filter 21 and the band-pass filter 22 are not disposed.

Usually, the antenna feeding network may be electrically connected to the low-pass filter 21.

By integrating the antenna feeding network into the integrated filter system, the antenna feeding network may be conveniently applied to the antenna and the antenna system, so that the antenna feeding network itself has a certain filtering capability, and a connector required between the antenna feeding network and the filter circuit 2 in the conventional technology may be omitted, and further, when the antenna feeding network is applied to the antenna and the antenna system, integration, miniaturization and lightweight may be achieved.

Preferably, the antenna feeding network is a microstrip antenna feeding network, and the microstrip antenna feeding network is arranged on the corresponding dielectric slab.

The integrated filter system in the present invention has the following beneficial effects:

(1) By integrating the filter circuit 2, which is, the low-pass filter 21 and the band-pass filter 22, to the dielectric slab assembly 1, the metal connecting rod low-pass filter 2′ in the conventional technology may be omitted, so that integration, miniaturization and lightweight are achieved, and costs are reduced.

(2) By respectively configuring the low-pass filter 21 and the band-pass filter 22 in the filter circuit 2 as a microstrip form, integration, miniaturization and lightweight are further achieved, and the stability of the whole performance is improved.

(3) A coaxial cavity filter 3 is added in the integrated filter system, and by means of the advantages of a great Q value and a good rectangle coefficient and the like of the coaxial cavity filter 3, disadvantages of a high Q value and a great insertion loss value of the microstrip-type filter may be remedied, thereby further satisfying the whole performance requirement. In addition, because the integrated filter system itself has good filtering performance, requirements on the quantity of cavities of the cavity filter may be reduced.

(4) By wholly integrating the antenna feeding network into the integrated filter system, the antenna feeding network itself has a certain filtering feature, so that the antenna feeding network may be conveniently applied to the antenna and the antenna system, which helps to achieve the integration and miniaturization. In addition, the antenna feeding network may be directly connected to the filter circuit 2 in the integrated filter system, so that a connector required in the conventional technology may be omitted.

The foregoing descriptions are merely implementations of the present invention, and are not intended to limit the patent scope of the present invention. Any equivalent structure or process changes made by using the specification and the accompanying drawing of the present invention, which are directly or indirectly applied in other related technical fields, should be all included in the patent protection scope of the present invention.

1. An integrated filter system, comprising:
a dielectric slab assembly; and
a filter circuit arranged on the dielectric slab assembly, wherein
the filter circuit comprises a low-pass filter and a band-pass filter connected to one another in series.

2. The integrated filter system according to claim 1, wherein
the dielectric slab assembly comprises a dielectric slab, and the low-pass filter and the band-pass filter are both arranged on the dielectric slab.

3. The integrated filter system according to claim 1, wherein
the dielectric slab assembly comprises two dielectric slabs, the low-pass filter is arranged on one dielectric slab, and the band-pass filter is arranged on the other dielectric slab.

4. The integrated filter system according to claim 1, wherein
the low-pass filter is a microstrip low-pass filter.

5. The integrated filter system according to claim 4, wherein
the low-pass filter is a high-low impedance microstrip low-pass filter.

6. The integrated filter system according to claim 1, wherein
the band-pass filter is a microstrip band-pass filter.

7. The integrated filter system according to claim 6, wherein
the microstrip band-pass filter implements a part of band-pass functions, and the microstrip band-pass filter and an externally-connected cavity band-pass filter jointly achieve a band-pass filtering effect.

8. The integrated filter system according to claim 2, wherein
the dielectric slab is a PCB.

9. The integrated filter system according to claim 1, wherein
the integrated filter system comprises a coaxial cavity filter electrically connected to the band-pass filter on the dielectric slab assembly.

10. The integrated filter system according to claim 9, wherein
the coaxial cavity filter is a band-pass filter.

11. The integrated filter system according to claim 10, wherein
the coaxial cavity filter is configured to achieve a part of band-pass filtering effects.

12. The integrated filter system according to claim 10, wherein
the band-pass filter and the coaxial cavity filter are connected to one another by means of a cable.

13. The integrated filter system according to claim 12, wherein the cable is connected to the band-pass filter and the coaxial cavity filter in a welding or screw fastening manner.

14. An antenna system, comprising the integrated filter system according to claim 1, wherein
an antenna feeding network in the antenna system and the integrated filter system are integrated to a same dielectric slab assembly.

15. The antenna system according to claim 14, wherein the antenna feeding network is a microstrip antenna feeding network.
